(19) United States
(12) Patent Application Publication
(10) Pub. No.: US 2008/0188225 A1
(43) Pub. Date: Aug. 7, 2008

(54) PERFORMING HANDOVER AND NETWORK CONNECTION IN WIRELESS COMMUNICATION SYSTEM

(75) Inventors: Seong-Jin Park, Gyeonggi-Do (KR); Sung-Hun Hong, Seoul (KR); Ki-Taek Song, Seoul (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG Electronics Inc.

(21) Appl. No.: 11/853,728

(22) Filed: Sep. 11, 2007

(30) Foreign Application Priority Data
Feb. 7, 2007 (KR) 10-2007-0012934
Feb. 7, 2007 (KR) 10-2007-0012935

(51) Int. Cl. H04Q 7/20

(52) U.S. Cl. 455/438

(57) ABSTRACT

The present invention relates to performing handover in a wireless communication system including informing a serving base station of a start of a handover operation to a target base station when bandwidth is allocated by serving base station during a particular time period, requesting cancellation of the handover operation from the serving base station when the handover operation to the target base station fails during the particular time period, and communicating data via the serving base station upon the handover operation being canceled according to the cancellation request. The present invention further relates to connecting to a network including turning on power of a mobile terminal, obtaining a time period from when power was turned off to when power is turned on, obtaining previous network scanning results if the obtained time period is less than a pre-set value, and connecting to the network using the previous network scanning results.

### CROSS-REFERENCE TO RELATED APPLICATIONS

Pursuant to 35 U.S.C. §119(a), this application claims the benefit of earlier filing date and right of priority to Korean Application No. 10-2007-0012935, filed on Feb. 7, 2007, and Korean Application No. 10-2007-0012934, filed on Feb. 7, 2007, the contents of which are hereby incorporated by reference herein in their entirety.

### FIELD OF THE INVENTION

The present invention relates to performing a handover operation in a wireless communication system and, more particularly, to connecting to a network and facilitating re-connection to the network when the handover operation fails.

### BACKGROUND OF THE INVENTION

Recently, in line with the advancement of communications, a third-generation mobile communication system, such as an International Mobile Telecommunication 2000 system (IMT-2000) (e.g., Code Division Multiple Access (CDMA) 2000 1X, 3X, EV-DO, Wideband CDMA (WCDMA), etc.), is being commercialized. Furthermore, to allow users to use a fast wireless Internet service at low cost, IEEE 802.16 specifications have been defined. Accordingly, Wimax or WiBro (Wireless Broadband Internet) technologies are being commercialized.

WiBro technology facilitates mobility, wherein a handover operation may be required. However, handover over using the WiBro technology has the following shortcomings, as shown in FIG. 1.

FIG. 1 is a flow chart illustrating a handover method according to the related art. Referring to FIG. 1, while utilizing the WiBro technology, when handover of a terminal from an original base station to a target base station fails, much time is needed for the terminal to re-enter the original base station. Thus, established communication can be disconnected or delayed. This will be described in detail as follows.

First, it is assumed that data is transmitted and received between a mobile station (MS) 10 and a first base station (BS) 20 (1). In such situations, when handover is required due to mobility (location movement), the MS 10 requests the first BS 20 to perform a handover operation to a second BS 30 (2). Accordingly, the first BS 20 responds to the request (3). Then, the MS 10 requests a bandwidth allocation from the first BS 20 (4). Thereafter, the first BS 20 allocates a bandwidth in response to the request (5). The MS 10 then informs the first BS 20 about a start of the handover operation to the second BS 30 (6). As a result, the first BS 20 stops data transmission to the MS 10 (7). Subsequently, the MS 10 attempts handover but fails due to an unexpected error (8). The MS 10 recognizing the handover failure requests allocation of a bandwidth from the first BS 20 (9). The first BS 20 then allocates a bandwidth according to the request of the MS 10 (10). The MS 10 then requests the first BS 20 to cancel the handover (11). Finally, the first BS 20 resumes data transmission which had been previously interrupted (12, 13).

As described above, in the related art WiBro technology, when handover fails, the complexity of a procedure that follows may cause the data transmission to be delayed or disconnected.

Meanwhile, in the WiMax/WiBro communication technologies, as well as the third-generation communication technologies described above, in general, when a wireless communication device is turned on, the device scans the entire network to select an available channel, and performs communication via the selected channel. However, because the wireless communication device scans the entire network to select the available channel, a problem arises because communication is performed only after a prolonged delay after the wireless communication device is turned on. This problem is aggravated when a user urgently needs to perform communication.

### SUMMARY OF THE INVENTION

The present invention is directed to performing handover in a wireless communication system.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention is embodied in a method for performing handover in a wireless communication system, the method comprising informing a serving base station of a start of a handover operation to a target base station when bandwidth is allocated by the serving base station during a particular time period, requesting cancellation of the handover operation from the serving base station when the handover operation to the target base station fails during the particular time period, and communicating data via the serving base station upon the handover operation being canceled according to the cancellation request. Preferably, the particular time period is a time period during which the serving base station maintains connection information with a mobile terminal.

In one aspect of the invention, the method further comprises requesting the serving base station to perform the handover operation, and receiving a response to the request from the serving base station. Preferably the particular time period is designated in a resource maintain time field of the response. Preferably, the response comprises information related to the particular time period. Preferably, the method further comprises requesting the serving base station to allocate bandwidth for performing the handover operation.

In another aspect of the invention, the method further comprises receiving a request for performing the handover operation from the serving base station. Preferably, the request comprises information related to the particular time period.

In accordance with another embodiment of the present invention, a method for performing handover in a wireless communication system comprises allocating bandwidth during a particular time period, receiving information from a mobile terminal related to a start of a handover operation to a target base station, receiving a request to cancel the handover operation during the particular time period when the handover operation to the target base station fails, and communicating data with the mobile terminal upon receiving the request to cancel the handover operation.

In one aspect of the invention, the method further comprises receiving from the mobile terminal a request for performing the handover operation, and transmitting a response to the request to mobile terminal. Preferably, the response comprises information related to the particular time period. Preferably, the response comprises a resource maintain time field designating the particular time period.

In another aspect of the invention, the method further comprises transmitting a request to the mobile terminal for performing the handover operation. Preferably, the request comprises information related to the particular time period.

In accordance with another embodiment of the present invention, a mobile terminal for performing a handover operation in a wireless communication system comprises an RF transmitting/receiving unit wirelessly communicating with a serving base station, and a controller controlling the RF transmitting/receiving unit for performing a handover operation to a target base station when bandwidth is allocated by the serving base station during a particular time period, and requesting cancellation of the handover operation from the serving base station without a separate bandwidth allocation when the handover operation to the target base station fails during the particular time period.

In accordance with another embodiment of the present invention, a base station for performing handover in a wireless communication system comprises a base station controller allocating bandwidth during a particular time period for facilitating a handover operation of a mobile terminal to a target base station, receiving a request to cancel the handover operation during the particular time period when the handover operation to the target base station fails, and communicating data with the mobile terminal upon receiving the request to cancel the handover operation.

In accordance with another embodiment of the present invention, a method for connecting to a network in a wireless communication system comprises turning on power of a mobile terminal, obtaining a time period from when power was turned off to when power is turned on, obtaining previous network scanning results if the obtained time period is less than a pre-set value, and connecting to the network using the previous network scanning results.

Preferably, the method further comprises scanning the network using the obtained previous network scanning results. Preferably, obtaining the time period from when power was turned off to when power is turned on comprises obtaining a time at which power was turned off, and calculating a difference between a current time and the time at which power was turned off. Preferably, the previous network scanning results comprise at least one of a frequency allocated from at least one of a serving base station and a neighbor base station, a preamble, power information; and a time-offset.

Preferably, connecting to the network comprises locally scanning the network using the previous network scanning results, determining whether results of the local scanning are satisfactory, and connecting to the network using the local scanning results if the local scanning results are satisfactory.

In one aspect of the invention, the method further comprises obtaining network information if the local scanning results are not satisfactory, and scanning the entire network using the obtained network information. Preferably, the network information comprises at least of an allocation frequency, a preamble, and a preferred roaming list (PRL).

In accordance with another embodiment of the present invention, a communication device for connecting to a network in a wireless communication system comprises an RF transmitting/receiving unit wirelessly connected to a network, and a controller controlling the RF transmitting/receiving unit for determining whether a time period from when power of the communication device was turned off to when power is turned on is less than a pre-set value, and connecting to the network using previous network scanning results if the time period is less than the pre-set value.

Preferably, the communication device is compatible with at least one of CDMA, GSM, GRPS, TDMA, IMT-2000, WCDMA, HSDPA, IEEE 802.11 and IEEE 802.16 technologies. Preferably, the communication device is at least one of a mobile phone, a personal digital assistant (PDA), a multimedia reproducing device, a game machine and a computer.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 is a flow chart illustrating a handover process in accordance with the related art.

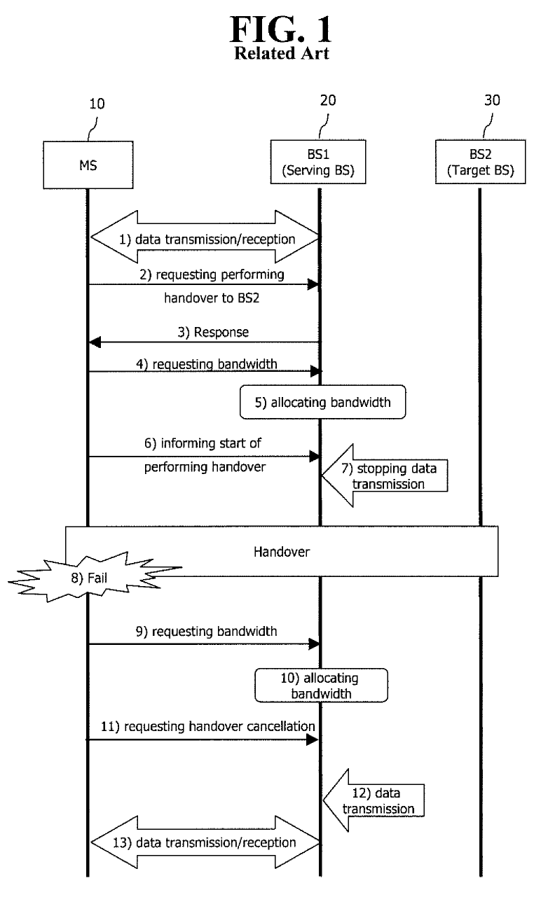

FIG. 2 is a flow chart illustrating a handover method in accordance with a first embodiment of the present invention.

FIG. 3 is another flow chart illustrating a handover method in accordance with the first embodiment of the present invention.

FIG. 4 is a flow chart illustrating a handover method in accordance with a second embodiment of the present invention.

FIG. 5 is another flow chart illustrating a handover method in accordance with the second embodiment of the present invention.

FIG. 6 illustrates a construction of a communication device in accordance with the first and second embodiments of the present invention.

FIG. 7 is a flow chart illustrating a method for accessing a network in accordance with a third embodiment of the present invention.

FIG. 8 illustrates a construction of a communication device in accordance with the third embodiment of the present invention.

### DETAILED DESCRIPTION OF THE PREFERRED EMBODIMENTS

The present invention is related to performing handover in a wireless communication system. Exemplary embodiments of the present invention will now be described in detail with reference to the accompanying drawings.

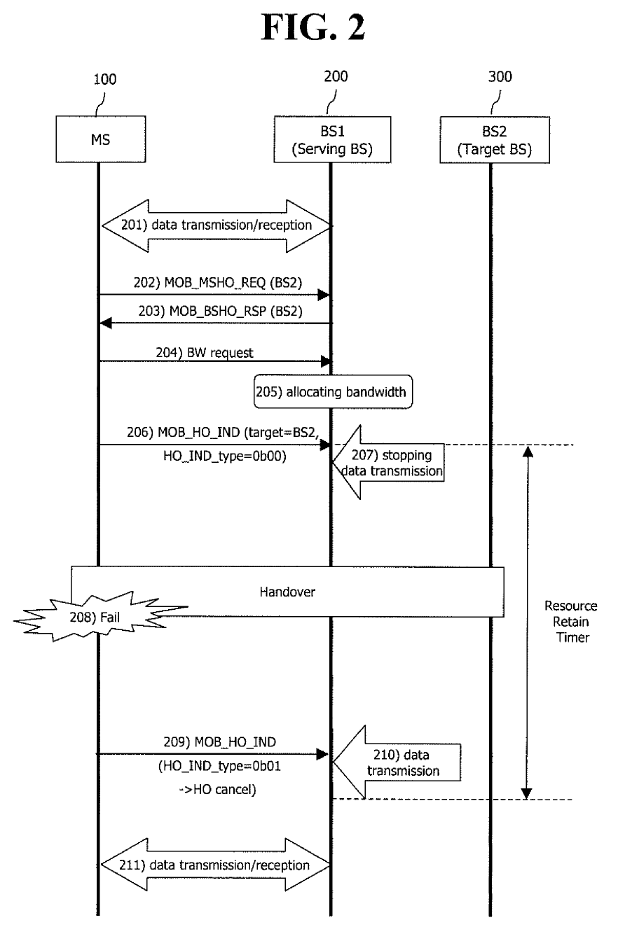

FIG. 2 is a flow chart illustrating a handover method in accordance with a first embodiment of the present invention. Referring to FIG. 2, when a mobile station (MS) 100 requests a bandwidth allocation for performing handover operation, a first base station (BS) 200 allocates the bandwidth, and maintains the bandwidth for a particular time period so that the MS 100 does not need to re-request a bandwidth allocation in case the handover operation fails. This will be described in detail as follows.

As shown in FIG. 2, data is transmitted and received between the MS 100 and the first BS 200 (201). In such situations, when handover is required due to mobility (location movement), the MS 100 requests the first BS 200 to perform a handover operation to a second BS 300 (202). Preferably, the request for handover may be performed through a handover request message, e.g., a MOB_MSHO_REQ message. The handover request message may include a parameter notifying a handover request to a target base station, namely, the second BS 300.

The first BS 200 responds to the request (203). Preferably, the response can be made (performed) through a handover response message, e.g., a MOB_BSHO_RSP message. The handover response message may include a parameter informing the MS 100 of a target base station for which handover is possible, e.g., the second BS 300. In addition, the handover response message may include at least one of a resource maintain flag and a resource maintain time field.

The resource maintain flag indicates whether the first BS 200 should maintain or delete its connection information with the MS 100 when it receives a handover start message from the MS 100. The resource maintain time field includes information related to a time during which the connection information with the MS 100 is to be retained. By using the resource maintain flag and the resource maintain time flag, if handover fails, the MS 100 can recognize whether handover can be canceled without re-requesting a bandwidth allocation, and recognize a time limit until when such handover cancellation is possible if the handover can be canceled.

Subsequently, the MS 100 requests an allocation of bandwidth from the first BS 200 to perform handover (204). Preferably, the request for bandwidth allocation is accomplished by transmitting a bandwidth allocation message, e.g., a BW request message. The first BS 200 then allocates bandwidth during a particular time period in response to the request (205). Here, the particular time period is a time period designated in the resource maintain time flag.

Preferably, the MS 100 informs the first BS 200 about the start of performing handover to the second BS 300 (206). The start of performing handover may be accomplished by transmitting a handover start message, e.g., a MOB_HO_IND message. Preferably, the handover start message includes a parameter indicating the target base station to which handover is to be performed, namely, the second BS 300. Furthermore, the handover start message may include a parameter indicating handover, e.g., HO_IND_type=0b00.

The first BS 200 then stops data transmission to the MS 100 (207). Thereafter, it is assumed that the MS 100 attempts to perform handover but fails due to an unexpected error (208). When the handover fails, the MS 100 checks whether a particular time period for which the bandwidth is allocated has lapsed. Here, the MS 100 may check whether the particular time has lapsed or not with reference to one or more of the resource maintain flag and resource maintain time field included in the handover response message. If the particular time period has not lapsed, the MS 100 requests handover cancellation from the first BS 200 (209). Preferably, the request for handover cancellation is accomplished by transmitting a handover cancel message, e.g., a MOB_HO_IND message. Here, the handover cancel message may include an HO cancel parameter indicating the handover cancellation. In addition, the handover cancel message may include an HO_IND_type=0b01 parameter requesting an update of base station information. The first BS 200 then resumes data transmission which had been previously stopped (210, 211).

As described above, in accordance with the first embodiment of the present invention, to cope with the situation of handover failure, the first BS 200 allocates bandwidth during a particular time period so that the MS 100 can cancel the handover operation without re-requesting a bandwidth allocation. Thus, delay or disconnection of data transmission and reception due to the handover failure can be reduced. In addition, because an additional bandwidth allocation request is omitted, network resources can be saved.

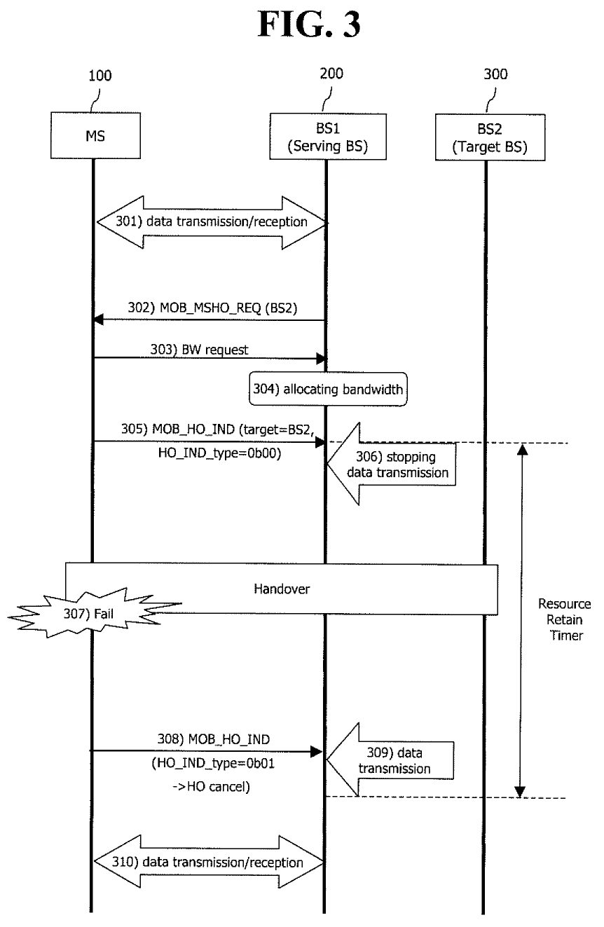

FIG. 3 is another flow chart illustrating a handover method in accordance with the first embodiment of the present invention. Referring to FIG. 3, the handover method depicted is similar to the handover method illustrated in FIG. 2; however, procedures for when the first BS 200 requests a handover operation are shown (302). Preferably, at least one of a resource maintain flag and a resource maintain time field, as described above, may be included in a handover request message transmitted by the first BS 200 to the MS 100. The rest of the handover operations are the same as those in FIG. 2. Therefore, their description will be omitted.

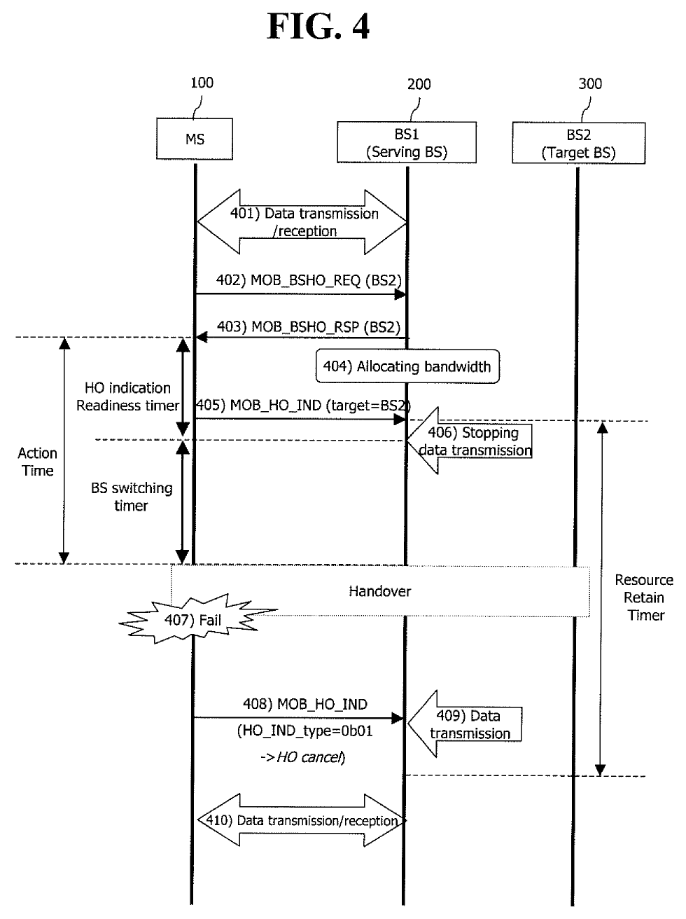

FIG. 4 is a flow chart illustrating a handover method in accordance with a second embodiment of the present invention, wherein a process of requesting bandwidth for performing a handover operation is omitted. Referring to FIG. 4, data is transmitted and received between the MS 100 and the first BS 200 (401). In such situations, when handover is required due to mobility (location movement), the MS 100 requests the first BS 200 to perform handover to a second BS 300 (402). Preferably, the handover request is performed through a handover request message, e.g., a MOB_MSHO_REQ message. The handover request message may include a parameter notifying the BS 200 of a handover request to a target base station, namely, the second BS 300.

Subsequently, the first BS 200 responds to the request (403). Preferably, the response is made (performed) through a handover response message, e.g., a MOB_BSHO_RSP message. The handover response message may include a parameter notifying the MS 100 of a target base station for which handover is possible, e.g., the second BS 300. In addition, the handover response message may include time information indicating an amount of time allotted for the MS 100 to inform the first BS 200 about the start of the handover operation. For example, such time information may an HO indication readiness timer. Also, the handover response message may include a BS switching timer indicating an amount of time allotted for the MS 100 to perform handover. Moreover, as stated above, the handover response message may include at least one of the resource maintain flag and the resource maintain time field.

The first BS 200 allocates bandwidth during a particular time period in response to the handover request (404). Preferably, the particular time period is a time period designated in the resource maintain time flag. The MS 100 then informs the first BS 200 about the start of the handover operation to the second BS 300. Preferably, the start of the handover operation begins within the time period included in (provided by) the HO indication readiness timer. The handover operation may be started by transmitting a handover start message, e.g., a MOB_HO_IND message (405). Preferably, the handover start message includes a parameter indicating the target base station to which handover is to be performed, namely, the second BS 300. Furthermore, the handover start message may include a parameter indicating handover, e.g., HO_IND_type=0b00. Accordingly, the first BS 200 stops data transmission to the MS 100 (406).

Thereafter, it is assumed that the MS 100 attempts to perform handover but fails due to an unexpected error (407). When the handover fails, the MS 100 checks whether the particular time period for which the bandwidth is allocated has lapsed. Preferably, the MS 100 may check whether the particular time period has lapsed with reference to one or more of a resource maintain flag and resource maintain time field included in the handover response message. If the particular time period has not lapsed, the MS 100 requests handover cancellation from the first BS 200 (408). Preferably, the request for handover cancellation is accomplished by transmitting a handover cancel message, e.g., a MOB_HO_IND message. The handover cancel message may include an HO cancel parameter indicating the handover cancellation. In addition, the handover cancel message may include an HO_IND_type=0b01 parameter requesting an update of base station information. The first BS 200 then resumes data transmission which had been previously stopped.

As described above, in accordance with the second embodiment of the present invention, the process of requesting bandwidth for performing handover is omitted to thus quickly perform handover. In addition, to cope with the situation of handover failure, the first BS 200 allocates bandwidth during a particular time period so that the MS 100 may cancel handover without requesting a bandwidth allocation.

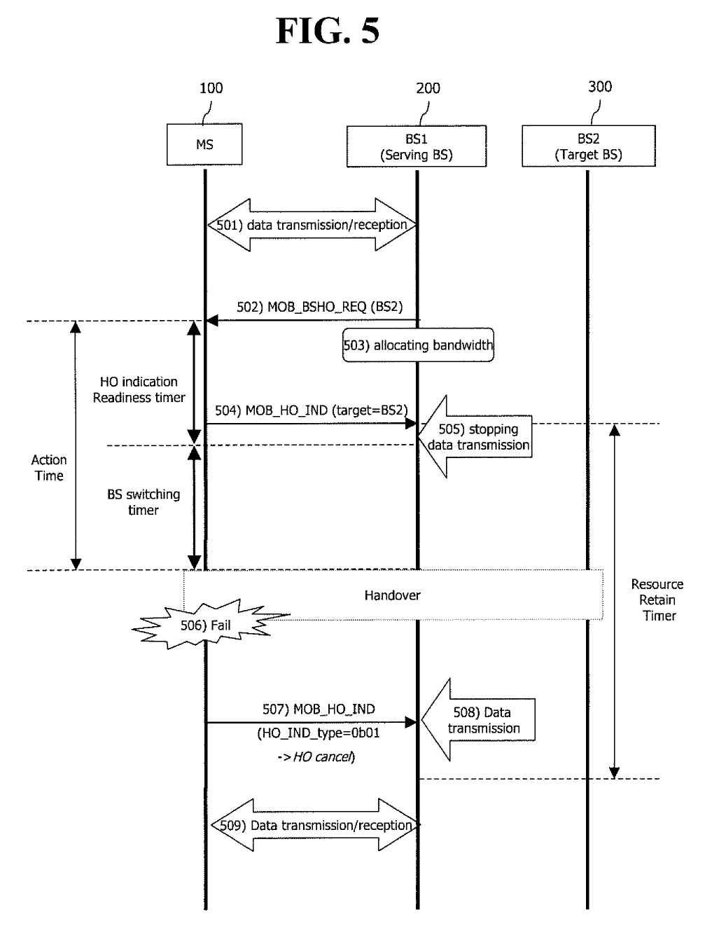

FIG. 5 is another flow chart illustrating a handover method in accordance with the second embodiment of the present invention. Referring to FIG. 5, the handover method depicted is similar to the handover method illustrated in FIG. 4; however, procedures for when the first BS 200 requests a handover operation are shown (502). Preferably, the handover request message transmitted by the first BS 200 to the MS 100 includes an HO indication readiness timer and a BS switching timer. In addition, the handover request message may include at least one of a resource maintain flag and a resource maintain time field. The rest of the handover operations are the same as those in FIG. 4. Therefore, their description will be omitted.

In accordance with the present invention, the handover methods according to the first and second embodiments, as shown in FIGS. 2 to 5, may be implemented by software, hardware or a combination including both. For example, the method according to the present invention may be stored in a storage medium (e.g., an internal memory of a mobile terminal, a flash memory, a hard disk, etc.), and may be implemented as codes or command languages in a software program that can be executed by a processor (e.g., an internal microprocessor of the mobile terminal).

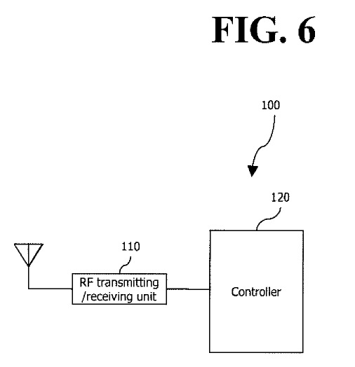

FIG. 6 illustrates a construction of a communication device in accordance with the first and second embodiments of the present invention. Referring to FIG. 6, a communication device 100 employing the methods of the first and second embodiments described above may include an RF transmitting/receiving unit 100 and a controller 120.

Preferably, the RF transmitting/receiving unit 110 includes electronic components for transmitting and receiving radio signals. The RF transmitting/receiving unit 110 is electrically connected with the controller 120, and performs a radio connection with the serving base station under the control of the controller 120.

The controller 120 performs handover to the target base station after receiving a bandwidth allocation during a particular time period from the serving base station by controlling the RF transmitting/receiving unit 110. If the handover fails, and if still within the time designated in the resource maintain time field, the controller 120 requests handover cancellation from the serving base station without a separate bandwidth allocation. Other procedures may be the same as described above. Therefore, their description will be omitted.

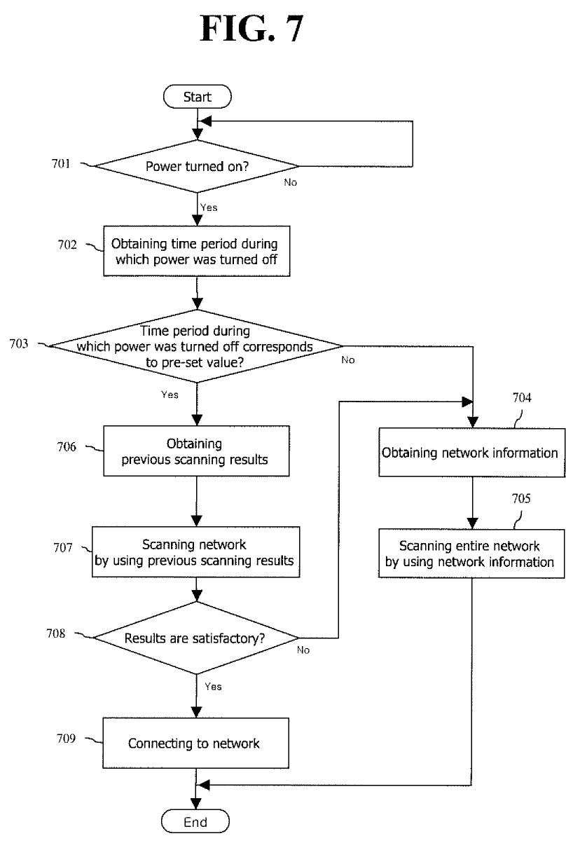

FIG. 7 is a flow chart illustrating a method for quickly connecting to a network in accordance with a third embodiment of the present invention. Referring to FIG. 7, when power of a mobile communication device is turned on, and an elapsed time after power was turned off is within a pre-set value, a network is scanned locally using previously scanned information. This will be described in detail as follows.

After power is turned on (701), an elapsed time period during which power was turned off is obtained (702). The time period can be ascertained by calculating a difference between a time at which the power was turned off and a current time. Preferably, the time at which power was turned off is stored in a memory.

Subsequently, the time period during which power was turned off is compared to a pre-set value (703). Preferably, the pre-set value can be arbitrarily set and changed according to a user pattern. For example, when mobility (location movement) occurs frequently, the pre-set value can be set to a small value. If mobility does not occur frequently, the pre-set value can be increased.

When the time period during which power was turned off is greater than, or does not correspond to, the pre-set value, network information is obtained (704). The network information may comprise allocation frequency and a preamble, or one or more of a Preferred Roaming List (PRL) in case of a CDMA system. The entire network is then scanned using the obtained network information (705). For example, a currently available base station is searched through scanning and various information with respect to the available base station is obtained.

Meanwhile, when the time period during which power was turned off is less than, or corresponds to, the pre-set value, previous scanning results are obtained (706). Preferably, the previously scanned results are stored in a memory. The previous scanning results may include information regarding the serving base station and a neighbor base station. For example, the previous scanning results may include at least one of an allocation frequency, a preamble, power, and time-offset of the serving base station or one or more neighbor base stations.

The network is then locally scanned using the previously scanned results (707). For example, a currently available base station is scanned using the information regarding the serving base station or the neighbor base stations, and various information regarding the currently available base station is obtained.

Thereafter, results of the local scanning are checked to be satisfactory (708). If the results are satisfactory, the mobile communication device is connected to a suitable network using the scanned results (709) and the process is terminated. If, however, the results are not satisfactory, the process proceeds to obtain network information (704).

In accordance with the present invention, the method according to the third embodiment as described so far can be applied to a communication device that supports at least one of CDMA, GSM, GPRS, TDMA, IMT-2000, WCDMA, HSDPA, IEEE802.11 and IEEE 802.16 technologies, but not limited thereto. The above-described method can be implemented by software, hardware and their combination. For example, the method according to the present invention may be stored in a storage medium (e.g., an internal memory of a mobile terminal, a flash memory, a hard disk, etc.), and may be implemented as codes or command languages in a software program that can be executed by a processor (e.g., an internal microprocessor of the communication device).

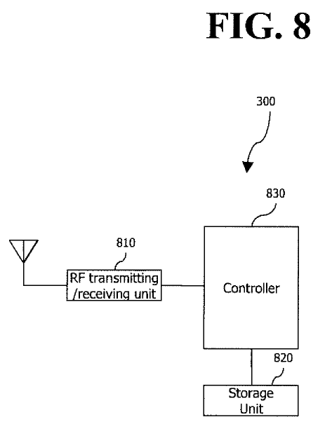

FIG. 8 illustrates a construction of a communication device in accordance with the third embodiment of the present invention. Referring to FIG. 8, a communication device 800 implementing the above-described method may include an RF transmitting/receiving unit 810, a storage unit 820, and a controller 830.

The RF transmitting/receiving unit 810 may include electronic components for transmitting and receiving radio signals. Preferably, the RF transmitting/receiving unit 810 may include electronic components for supporting communication of CDMA, GSM, GPRS, TDMA, IMT-2000, WCDMA, HSDPA, IEEE802.11 and IEEE 802.16 signals, but not limited thereto. The RF transmitting/receiving unit 810 is electrically connected with the controller 830 and performs communication under the control of the controller 830.

The storage unit 820 can be formed as a DRAM (Dynamic Random Access Memory), an SRAM (Statically Random Access Memory), an SDRAM, a flash memory, a NAND flash or a hard disk. The storage unit 820 stores information related to the time period during which power is turned off as mentioned above. In addition, the storage unit 820 stores the pre-set time, obtained network information and network scanned information. The controller 830 may include multiple semiconductor devices, and is electrically connected with the RF transmitting/receiving unit 810 and the storage unit 820 to control the storage unit 820.

In accordance with the present invention, when power is turned on, the controller 830 obtains from the storage unit 320 a time at which power was turned off, and calculates the time period during which power was turned off using the obtained time. The controller 830 then checks whether the obtained time period during which power was turned off corresponds to a pre-set value. If the obtained time period corresponds to the pre-set value, the controller obtains previous scanning results from the storage unit 820 and locally scans the network using the obtained results.

The communication device 800 described above can be one of a mobile phone, a personal digital assistant (PDA), a multimedia reproducing device, a game machine, or a computer.

As so far described, the handover method according to the present invention has the following advantages. Because the first BS 200 allocates bandwidth during a particular time period to cope with the situation of handover failure, the MS 100 can cancel handover without requesting a bandwidth allocation. Thus, delay of data transmission and reception and disconnection due to the handover failure is reduced. In addition, because the request for bandwidth allocation is omitted, network resources are saved.

In addition, because the process of requesting bandwidth for performing handover may be omitted, handover can be quickly performed.

Moreover, when power is turned on, a network may be locally scanned using previous scanning information, and thus be quickly connected with the network. Therefore, a user's demand to urgently perform communication is met. Also, because the network is locally scanned, battery consumption is reduced.

This specification describes various illustrative embodiments of a method of the present invention. The scope of the claims is intended to cover various modifications and equivalent arrangements of the illustrative embodiments disclosed in the specification. Therefore, the following claims should be accorded the reasonably broadest interpretation to cover modifications, equivalents structures, and features that are consistent with the spirit and scope of the invention disclosed therein.

What is claimed is:

1. A method for performing handover in a wireless communication system, the method comprising:
informing a serving base station of a start of a handover operation to a target base station when bandwidth is allocated by the serving base station during a particular time period;
requesting cancellation of the handover operation from the serving base station when the handover operation to the target base station fails during the particular time period; and
communicating data via the serving base station upon the handover operation being canceled according to the cancellation request.

2. The method of claim 1, wherein the particular time period is a time period during which the serving base station maintains connection information with a mobile terminal.

3. The method of claim 1, further comprising:
requesting the serving base station to perform the handover operation; and
receiving a response to the request from the serving base station.

4. The method of claim 3, wherein the particular time period is designated in a resource maintain time field of the response.

5. The method of claim 3, wherein the response comprises information related to the particular time period.

6. The method of claim 3, further comprising requesting the serving base station to allocate bandwidth for performing the handover operation.

7. The method of claim 1, further comprising receiving a request for performing the handover operation from the serving base station.

8. The method of claim 7, wherein the request comprises information related to the particular time period.

9. A method for performing handover in a wireless communication system, the method comprising:
allocating bandwidth during a particular time period;
receiving information from a mobile terminal related to a start of a handover operation to a target base station;
receiving a request to cancel the handover operation during the particular time period when the handover operation to the target base station fails; and
communicating data with the mobile terminal upon receiving the request to cancel the handover operation.

10. The method of claim 9, further comprising:
receiving from the mobile terminal a request for performing the handover operation; and
transmitting a response to the request to mobile terminal.

11. The method of claim 10, wherein the response comprises information related to the particular time period.

12. The method of claim 10, wherein the response comprises a resource maintain time field designating the particular time period.

13. The method of claim 9, further comprising transmitting a request to the mobile terminal for performing the handover operation.

14. The method of claim 13, wherein the request comprises information related to the particular time period.

15. A mobile terminal for performing a handover operation in a wireless communication system, the mobile terminal comprising:
an RF transmitting/receiving unit wirelessly communicating with a serving base station; and
a controller controlling the RF transmitting/receiving unit for performing a handover operation to a target base station when bandwidth is allocated by the serving base station during a particular time period, and requesting cancellation of the handover operation from the serving base station without a separate bandwidth allocation when the handover operation to the target base station fails during the particular time period.

16. A base station for performing handover in a wireless communication system, the base station comprising:
a base station controller allocating bandwidth during a particular time period for facilitating a handover operation of a mobile terminal to a target base station, receiving a request to cancel the handover operation during the particular time period when the handover operation to the target base station fails, and communicating data with the mobile terminal upon receiving the request to cancel the handover operation.

17. A method for connecting to a network in a wireless communication system, the method comprising:
turning on power of a mobile terminal;
obtaining a time period from when power was turned off to when power is turned on;
obtaining previous network scanning results if the obtained time period is less than a pre-set value; and
connecting to the network using the previous network scanning results.

18. The method of claim 17, further comprising scanning the network using the obtained previous network scanning results.

19. The method of claim 17, wherein obtaining the time period from when power was turned off to when power is turned on comprises:
obtaining a time at which power was turned off; and
calculating a difference between a current time and the time at which power was turned off.

20. The method of claim 17, wherein the previous network scanning results comprise at least one of a frequency allocated from at least one of a serving base station and a neighbor base station, a preamble, power information; and a time-offset.

21. The method of claim 17, wherein connecting to the network comprises:
locally scanning the network using the previous network scanning results;
determining whether results of the local scanning are satisfactory; and
connecting to the network using the local scanning results if the local scanning results are satisfactory.

22. The method of claim 21, further comprising:
obtaining network information if the local scanning results are not satisfactory; and
scanning the entire network using the obtained network information.

23. The method of claim 22, wherein the network information comprises at least of an allocation frequency, a preamble, and a preferred roaming list (PRL).

24. A communication device for connecting to a network in a wireless communication system, the communication device comprising:
an RF transmitting/receiving unit wirelessly connected to a network; and
a controller controlling the RF transmitting/receiving unit for determining whether a time period from when power of the communication device was turned off to when power is turned on is less than a pre-set value, and connecting to the network using previous network scanning results if the time period is less than the pre-set value.

25. The communication device of claim 24, wherein the communication device is compatible with at least one of CDMA, GSM, GRPS, TDMA, IMT-2000, WCDMA, HSDPA, IEEE 802.11 and IEEE 802.16 technologies.

26. The communication device of claim 24, wherein the communication device is at least one of a mobile phone, a personal digital assistant (PDA), a multimedia reproducing device, a game machine and a computer.
